(19) United States
(12) Patent Application Publication
(10) Pub. No.: US 2026/0072242 A1
(43) Pub. Date: Mar. 12, 2026

(54) PRISM DRIVING DEVICE, CAMERA AND ELECTRONIC DEVICE

(71) Applicant: XIAMEN ZHONGHUI MICROELECTRONICS CO., LTD, Xiamen (CN)

(72) Inventors: Chaochon Chang, Taibei (CN); Huihuang Xu, Xiamen (CN)

(21) Appl. No.: 19/324,253

(22) Filed: Sep. 10, 2025

(30) Foreign Application Priority Data
Sep. 11, 2024 (CN) 202411269271.7

(51) Int. Cl. G02B 7/18; G02B 13/00; G03B 5/00; G03B 13/36; G03B 17/17; G03B 30/00

(52) U.S. Cl. CPC G02B 7/1805; G02B 13/0065; G03B 5/00; G03B 17/17; G03B 30/00; G03B 13/36; G03B 2205/003; G03B 2205/0069

(57) ABSTRACT

A prism driving device includes a carrier for carrying a prism, a rotatable member supporting the carrier, a base supporting the rotatable member, a first driving unit used for driving the carrier to rotate around a first axis relative to the rotatable member, a second driving unit used for driving the rotatable member to rotate around a second axis relative to the base, and a plate spring unit located on a −Y direction side of the carrier and the rotatable member. The first axis, the second axis and the Y direction are perpendicular with each other. The plate spring unit is connected between the carrier and the rotatable member to allow the carrier to rotate around the first axis. The plate spring unit is also connected between the rotatable member and the base to allow the rotatable member to rotate around the second axis.

### CROSS-REFERENCE TO RELATED APPLICATION

The present application claims priority of China Patent Application No. 202411269271.7, filed on Sep. 11, 2024, the contents of which are incorporated herein by reference.

### BACKGROUND OF THE INVENTION

### 1. Technical Field

The present application relates to prism driving devices, and in particular to a prism driving device, camera and electronic device having the prism driving device.

### 2. Description of Related Art

In the design and manufacture of modern optical equipment, periscopic prism driving devices, as a key technology achieving both long focal length and compact size, rely heavily on the internal optical path system design and the optimization of the prism driving mechanism to ensure imaging quality and device performance. In traditional periscopic prism driving devices, the mechanism for rotating the prism along an X-axis and a Y-axis (XY-axis in short), while meeting optical path adjustment needs to a certain extent, introduces the issue of optical path decentration. Although this XY-axis rotation allows for path adjustment within a range, it readily causes optical path decentration. This phenomenon not only affects image clarity and contrast but can also lead to image distortion and color aberration, severely limiting the device's imaging performance and user experience. This issue is particularly prominent in high-precision imaging and long-focal-length shooting scenarios, becoming a significant bottleneck restricting the performance improvement of periscopic prism driving devices.

Although prism driving device designs involving rotation along the XZ-axis also exist, aiming to optimize the precision and stability of optical path adjustment by changing the rotation axis, the realization of this design faces dual challenges of high assembly difficulty and increased cost. The complex mechanical structure, precise assembly requirements, and high-precision component matching not only raise technical difficulties during production but also increase manufacturing costs, limiting the adoption and popularization of this design in mass production and market applications.

Given the above problems and challenges, innovation and optimization in prism driving technology are particularly urgent.

### SUMMARY OF THE INVENTION

An objective of the present invention is to provide an improved prism driving device, camera and electronic device having the prism driving device.

The prism driving device at least includes a carrier, a rotatable member, a base, a first driving unit, a second driving unit, and a plate spring unit. The carrier is used for carrying a prism. The prism is used for refracting light entering from a Y-axis direction to a Z-axis direction perpendicular to the Y-axis direction. The rotatable member is used for supporting the carrier. The first driving unit is used for driving the carrier to rotate around a first axis relative to the rotatable member, and the first axis is parallel with an X-axis direction which is perpendicular to the Y-axis direction and the Z-axis direction. The base is used for supporting the rotatable member. The second driving unit is used for driving the rotatable member to rotate around a second axis relative to the base. The second axis is parallel with the Z-axis direction. The plate spring unit is used for connecting the carrier and the rotatable member and allowing the carrier to rotate around the first axis relative to the rotatable member. The plate spring unit is also used for connecting the rotatable member and the base and allowing the rotatable member to rotate around the second axis relative to the base. The plate spring unit is located on a −Y side of the carrier and the rotatable member.

In the present invention, the carrier, the rotatable member and the base support each other in turn and are connected via the plate spring from the −Y side, the prism is capable of rotating around the first and second axis accurately and stably without using traditional mechanical connectors like metal guide shafts or balls. This design reduces a number of the connectors and a device complexity, simplifies assembly of the product, improves production efficiency and device reliability, reduces maintenance costs, and facilitates mass production and rapid deployment of optical equipment. Furthermore, the −Y side placement of the spring unit further reduces their assembly difficulty. Furthermore, as the number of the connectors are reduced, the prism driving device may have a smaller size than the traditional prism driving device.

Rotation of the prism around the first and the second axis ensures the symmetry and stability of the optical path system, effectively preventing optical path decentration caused by prism position offset. This design is particularly important for high-resolution optical systems, preventing issues like imaging blur and decreased resolution due to decentration, thereby ensuring the imaging quality and resolution of the optical system to meet the needs of high-precision optical applications.

### BRIEF DESCRIPTION OF THE SEVERAL VIEWS OF THE DRAWINGS

The foregoing and other exemplary purposes, aspects and advantages of the present invention will be better understood in principle from the following detailed description of one or more exemplary embodiments of the invention with reference to the drawings, in which:

FIG. 1 is front view of an electronic device in accordance with an embodiment of the present invention.

FIG. 2 is a back view of the electronic device in FIG. 1.

FIG. 3 is an exploded view of a camera having an auto-focus module and a prism driving device in accordance with an embodiment of the present invention.

FIG. 4 is an enlarged view of part A in FIG. 1.

FIG. 5 is a perspective view of a rotatable member of the prism driving device in FIG. 3.

FIG. 6 is another perspective view of the rotatable member.

FIG. 7 is a perspective view of a carrier of the prism driving device in FIG. 3.

FIG. 8 is another perspective view of the carrier.

FIG. 9 is a partial perspective view of a base of the prism driving device in FIG. 3.

FIG. 10 is a partial exploded view of the camera in FIG. 3.

### DETAILED DESCRIPTION OF THE INVENTION

The invention will now be described in detail through several embodiments with reference to the accompanying drawings.

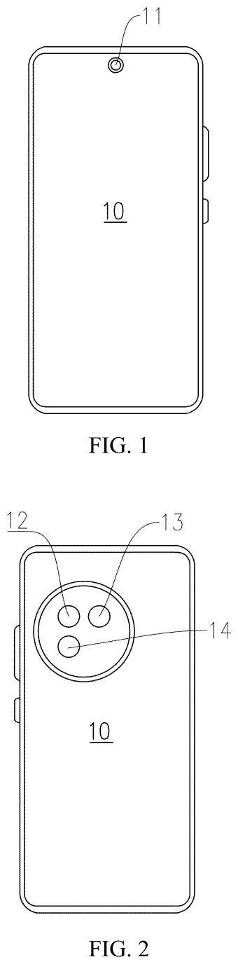

The electronic device in the present invention may include at least one camera for taking photos or recording. The electronic device may be a mobile phone, a personal digital assistant (PDA) computer, a tablet computer, a laptop, a laptop computer, a smart watch, a smart wristband, an in-vehicle computer, or a television. For example, please refer to FIG. 1 and FIG. 2, an electronic device 10 is a mobile phone having a front camera 11 and three back cameras 12, 13 and 14. The front camera 11 and the back camera 12 may be wide cameras (main cameras), the back camera 13 may be an ultra-wide camera or a wide-angle camera, and he back camera 14 may be a periscope telephoto camera with a longer focal length than the wide cameras.

The periscope telephoto camera 14 may use a prism to bend light at a 90-degree angle, allowing for a longer focal length to be housed horizontally within the slim body of the electronic device, enables users to bring faraway objects closer for shooting. This hardware-based design accomplishes true, lossless optical zoom.

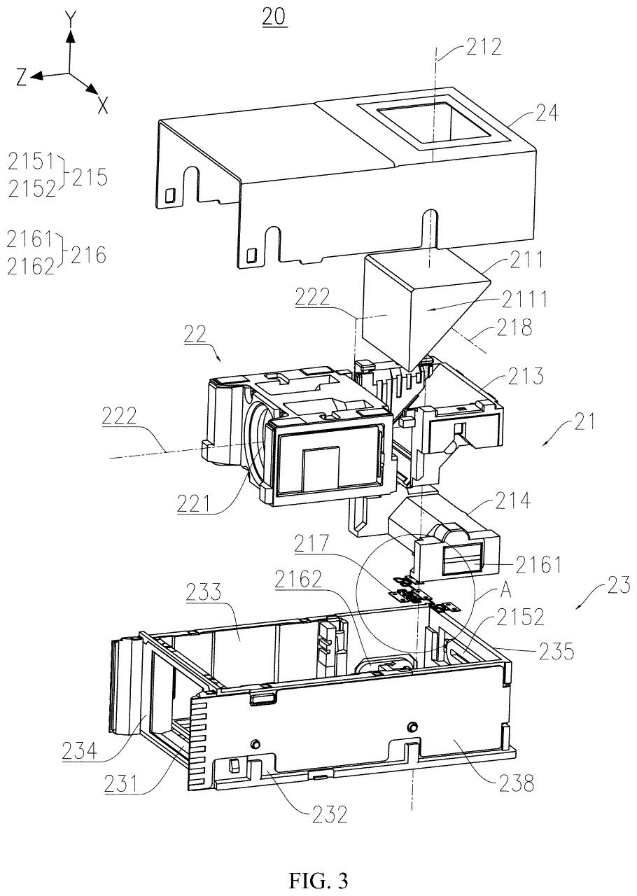

FIG. 3 illustrate an exploded view of a camera 20 according to an embodiment of the present invention. The camera 20 may be used as the periscope telephoto camera 14 of the electronic device 10.

The camera 20 mainly includes a prism driving device 21 used for carrying a prism 211, a lens driving device 22 used for carrying a lens module 221, a base 23, cover 24, and an image sensor module (not shown). The cover 24 is connected with the base 23 to form a receiving space for receiving the prism driving device 21 and the lens driving device 22.

The lens driving device 22 is an auto focus module, and its optical axis (second axis) is indicated in FIG. 3 with a number 222. The prism driving device 21 is also used as an OIS (optical image stabilization) module. On the light-exit side, an optical axis (second axis) of the prism driving device 21 is coincident with the second axis 222 of the lens driving device 22. On the light-entrance side, an optical axis (third axis) of the prism driving device 21 is referred to as a number 212.

For the convenience of describing the configuration of the camera 20, in the following description, a three-dimensional (3D) Cartesian coordinate system is introduced. The second axis 222 is parallel with a Z-axis of the 3D Cartesian coordinate system. The third axis 212 is parallel with a Y-axis of the 3D Cartesian coordinate system. The subject being photographed by the camara 20 is considered to be located in the +Y side of the Z axis direction (+Y-axis side).

The base 23 mainly includes a bottom board 231 which is substantially parallel with a plane defined by the X-axis and the Z-axis, and four walls substantially extending perpendicularly from four sides of the bottom board 231 towards the +Y side. The four walls include a +X side wall 232, a −X side wall 233, a +Z side wall 234 and a −Z side wall 235. The not shown image sensor module is connected to the +Z side wall 234, and an opening is defined in the +Z side wall 234 to allow light transmitting to the not sown image sensor. The base 23 may be made of nonconductive and non-magnetic materials, such as plastics.

The prism driving device 21 mainly includes a carrier 213, a rotatable member 214, the base 23, a first driving unit 215, a second driving unit 216, and a plate spring unit 217.

The carrier 213 is used for carrying the prism 211. The prism 211 is used for refracting light entering from the Y-axis direction to the Z-axis direction. The rotatable member 214 is used for supporting the carrier 213. The first driving unit 215 is used for driving the carrier 213 to rotate around a first axis 218 relative to the rotatable member, 214. The first axis 218 is parallel with the X-axis direction. The base 23 is used for supporting the rotatable member 214. The second driving unit 216 is used for driving the rotatable member 214 to rotate around the second axis 222 relative to the base 23. The second axis 222 is parallel with the Z-axis direction. The plate spring unit 217 is used for connecting the carrier 213 and the rotatable member 214 and allowing the carrier 213 to rotate around the first axis 218 relative to the rotatable member 214. The plate spring unit is also used for connecting the rotatable member 214 and the base 23 and allowing the rotatable member 214 to rotate around the second axis 222 relative to the base 23. The plate spring unit 217 is located on a −Y side of the carrier 213 and the rotatable member 214. The prism driving device 21 has low assembly difficulty, offering advantages of simple assembly and low cost.

In the embodiment, the first driving unit 215 and the second driving unit 216 are voice coil driving units. The first driving unit 215 includes a coil unit 2152 and a magnet unit 2151 opposed to each other with space. One of the coil unit 2152 and the magnet unit 2151 is fixed to the carrier 213, and the other of them is fixed to the base 23. In the embodiment, the coil unit 2152 is fixed to the −Z side wall 235 of the base 23, and the magnet unit 2151 is fixed to a −Z side surface of the carrier 213.

The second driving unit 216 includes two coil units 2162 and two magnet units 2161 opposed to each other with space. The coil units 2162 are fixed to one of the rotatable member 214 and the base 23, and the magnet units 2161 are fixed to the other of the rotatable member 214 and the base 23. In the embodiment, the coil units 2162 are fixed to the +X side wall 232 and the −X side wall 233 of the base 23, respectively, and the magnet units 2161 are fixed to a +X side surface and the −X side surface of the rotatable member 214. A flexible printed circuit board (FPCB) 238 may be fixed to outer surfaces of the +X side wall 232, the −Z side wall 235 and the −X side wall 233, and the coil units 2162 and the coil unit 2152 are electrically connected to the FPCB 238. The FPCB 238 is used for supplying power and control signals to the coils.

Each coil unit 2162 may include one or two or two more electrical coils connected electrically in series or in parallel. Each magnet units may include two flat permanent magnet pieces arranged side by side in the Y-axis direction with opposite magnetic poles.

The plate spring unit 217 may include one or two plate-like springs. The plate-like spring is also commonly known as a leaf spring, is a type of mechanical spring constructed from one or more flat, thin plates (called leaves) stacked together. Its primary function is to store energy under load and release it, providing shock absorption, load bearing, and vibration isolation. The plate spring unit 217 is substantially parallel to the plane defined by the X-axis and Z-axis.

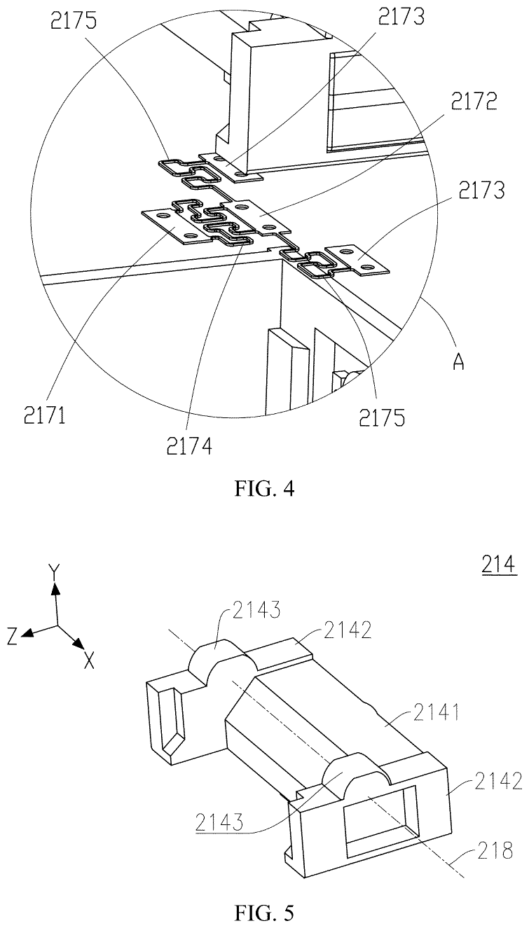

Please also refer to FIG. 4, in the embodiment, the plate spring unit 217 includes a first fixing part 2171 connected to a −Y side end of the carrier 213, a second fixing part 2172 connected to a −Y side end of the rotatable member 214, two third fixing parts 2173 connected to a bottom board 231 of the base 23, two first elastic parts 2174 connected between the first fixing part 2171 and the second fixing part 2172, and two second elastic parts 2175 connected between the two third fixing parts 2173 and the second fixing part 2172. The two first elastic parts 2174 are symmetrical about the second axis 222, and the two second elastic parts 2175 are also symmetrical about the second axis 222. The first elastic parts 2174 and the two second elastic parts 2175 are linear wrist parts which extend along the X direction and the Z direction alternately. The plate spring unit 217 may be made from a piece metal sheet, such as a stainless-steel sheet.

As the carrier 231, the rotatable member 214 and the base 23 support each other in turn and are connected via the plate spring unit 217 from the −Y side, the prism 211 is capable of rotating around the first and second axis 218, 222 accurately and stably without using traditional mechanical connectors like metal guide shafts or balls. This design reduces a number of the connectors and a device complexity, simplifies assembly of the product, improves production efficiency and device reliability, reduces maintenance costs, and facilitates mass production and rapid deployment of optical equipment. Furthermore, the −Y side placement of the spring unit 217 further reduces their assembly difficulty. Furthermore, as the number of the connectors are reduced, the prism driving device may have a smaller size than the traditional prism driving device.

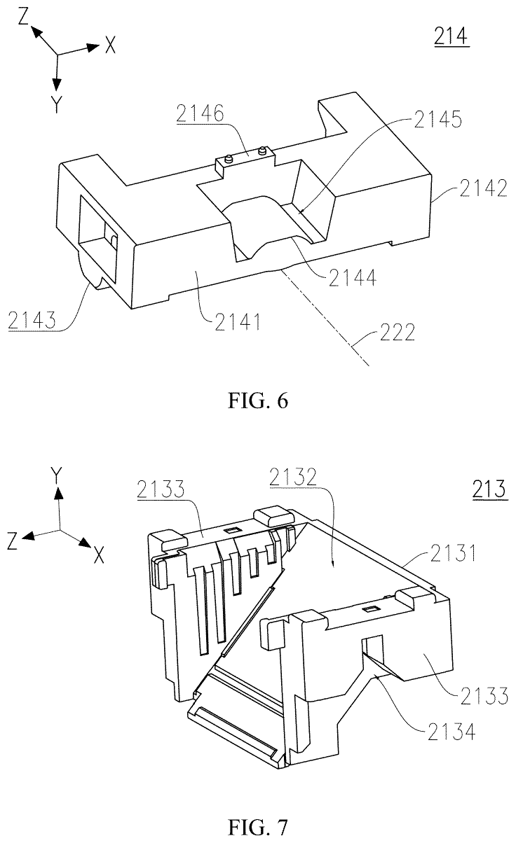

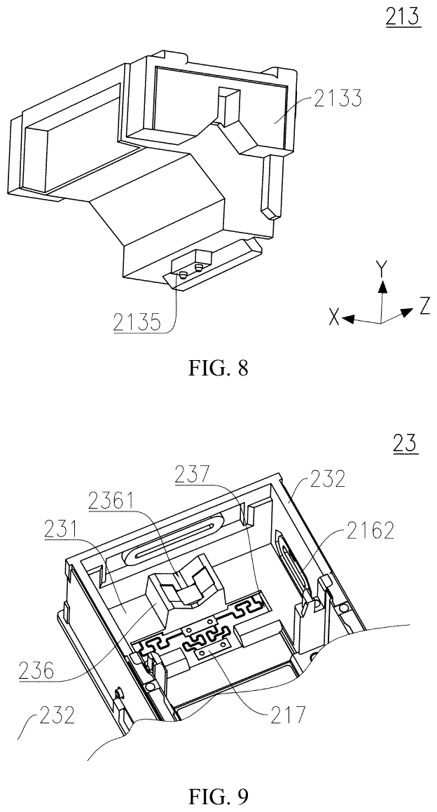

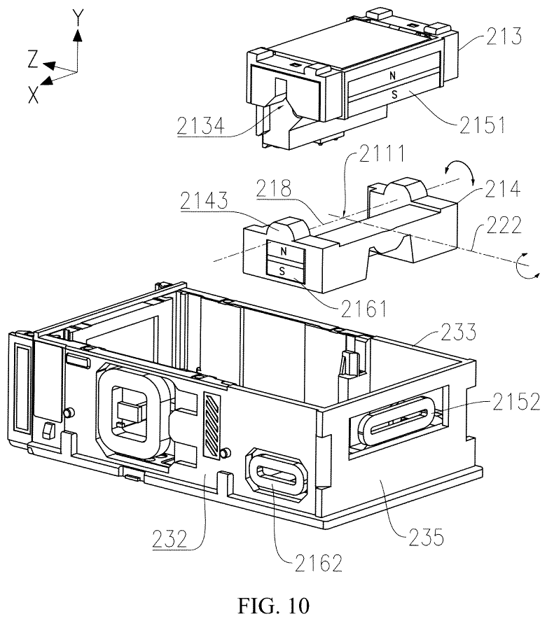

Please also refer to FIG. 5 to FIG. 10, the rotatable member 214 mainly includes a support beam 2141 arranged parallel to the X-axis direction, two first walls 2142 connected with two ends of the support beam 2141, two first pivot shafts 2143 arranged parallel to the X-axis direction and connected to +Y side ends of the two first walls 2142 respectively, and a second pivot shaft 2144 arranged parallel to the Z-axis direction and connected to a −Y side part of the support beam 2141. In detail, the −Y side part of the support beam 2141 defines a second recess 2145, the second pivot shaft 2144 is a pillar with a +Y side part thereof embedded in a bottom of the second recess 2145. Each first pivot shaft 2143 is also a pillar with a −Y side part thereof embedded in the +Y-axis side end of the first wall 2142. When viewed from the Y-axis direction, axes (the first axes 218 and the second axes 222) of the first pivot shafts 2143 and the second pivot shaft 2144 intersect at an optical center 2111 of the prism 211 (see FIG. 10). A fixing boss 2146 extends from the support beam 2141 of the rotatable member 214 towards the −Y side. The rotatable member 214 may be made of nonconductive and non-magnetic materials, such as plastics.

The carrier 213 mainly includes a bevel part 2131 having a bevel 2132 for abutting against the prism 211, and two second side walls 2133 connected to two sides of the bevel part 2131. Two first recesses 2134 are defined in the two second side walls 2133 respectively at positions opposite to the two first pivot shafts 2143. In detail, a width (size in the X-axis direction) of a lower part (−Y side part) of the second side wall 2133 is much thinner than that of an upper part (+Y side part) of the second side wall 2133, and the first recess 2134 is formed in a −Y side surface of the upper part of the second side wall 2133, its opening is oriented toward the first pivot shaft 2143. Thus, when +Y side parts of the two first pivot shafts 2143 are rotatable received in the two first recesses 2134 to allow relative rotation between the carrier 213 and the rotatable member 214, the two upper parts of the two second side walls 2133 are on top of the two first walls 2142 respectively, while the two lower parts of the two second side walls 2133 are located inside the two first walls 2142. Because the lower part of the second side wall 2133 is much thinner than that of the upper part of the second side wall 2133, a width of a composite structure formed by the first side wall 2142 and the second side wall 2133 is only slightly larger than the width of the first side wall 2142. Furthermore, the magnet unit 2161 may be fixed in a recess defined in the first side wall 2142 which has a similar width to that of the second side wall 2133, therefore, each component is fully utilized, making the prism driving device 21 simple in structure and narrow in width as a whole. The carrier 213 may be made of nonconductive and non-magnetic materials, such as plastics.

The carrier 213 further includes a boss 2135 extending from the bevel part 2131 towards the −Y side. A −Y side end of the boss 2135 is located at a +Z side of the fixing boss 2146 of the support beam 2141 of the rotatable member 214. The first fixing part 2171 of the plate spring unit 217 is connected to the boss 2135 and the second fixing part 2172 is connected to the fixing boss 2146 of the rotatable member.

Please also refer to FIG. 9, for supporting the rotatable member 214, a boss 236 protrudes upwardly from the bottom board 231 of the base 23, and defines a third recess 2361 in its top surface. The third recess 2361 is used for receiving the second pivot shaft 2144. The boss 236 is inserted in the second recess 2145 of the rotatable member 214 with the third recess 2361 receiving the second pivot shaft 2144 to allow relative rotation between the rotatable member 214 and the base 23. The fixing boss 2146 of the rotatable member 214 is located at a +Z side of the boss 236 of the base 23. The boss 236 and the base 23 may be integrally injection molded.

For fixing the two third fixing parts 2173 of the plate spring unit 217, providing sufficient deformation space for the plate spring unit 217, and minimizing the camera height as much as possible, an opening 237 is formed on the bottom board 231 of the base 23. The two third fixing parts 2173 of the plate spring unit 217 are connected to a −Y-axis side surface of the bottom board 231. The first fixing part 2171, the second fixing part 2172, the two first elastic parts 2174 and the two second elastic parts 2175 are located within the opening 237 and do not contact with sides forming the opening 237.

Depending on the opening 237, the plate spring unit 217 may be substantially parallel to a plane defined by the X-axis direction and the Z-axis direction. A height of the camera 20 is lowered than that of a traditional camera without a similar opening.

In operation, when the coils (the first and the second driving units 215, 216) are not energized, the rotatable member 214 is supported by the base 23 in a way that the second pivot shaft 2144 contacts with the third recess 2361 while the other part of the rotatable member 214 does not contact with the base 23. The carrier 213 is supported by the rotatable member 214 in a way that the two first pivot shafts 2143 contacts with the two first recesses 2134 while the other part of the carrier 213 does not contact with the rotatable member 214. That is, the carrier 213, the rotatable member 214 and the base are stacked together in the direction of the Y axis, while they also connected in turn by the plate spring unit 217 in the −Y side. This configures make the prism driving device is capable of working stably.

When the coil unit 2152 is energized, the magnet unit 2151 is actuated to move toward the +Y side or the −Y side and the carrier 213 moves along, depending on the first pivot shafts 2143 and the first recesses 2134, the carrier 213 rotates around the first axis 218. At the end of the rotation, the −Y side part of the bevel part 2131 and/or a −Y side part of the two second side walls 2133 of the carrier 213 may contact with the support beam 2141 of the rotatable member 214, thus a rotation angle of the carrier 213 may be limited.

When the coil units 2162 are energized, the magnet units 2161 are actuated to move toward the +Y side or the −Y side, the rotatable member 214 and the carrier 213 moves along together, depending on the second pivot shaft 2144 and the third recess 2361, the rotatable member 214 and the carrier 213 rotates around the second axis 222 together. At the end of the rotation, the −Y side part of the support beam 2141 of the rotatable member 214 may contact with the bottom board 231 or the boss 236 of the base 23, thus a rotation angle of the rotatable member 214 may be limited.

It is understandably, lubricating grease or gel (not shown) may be filled between the first pivot shafts 2143 and the first recesses 2134, and between the second pivot shaft 2144 and the third recess 2361 to reduce friction, improve system response speed, extend service life, improve the smoothness and precision of rotation, and reduce noise generated during rotation. This is crucial for optical systems requiring high-precision positioning and adjustment.

Rotation of the prism 211 about the X and Z axes ensures symmetry and stability of the optical path system, effectively preventing optical path decentration caused by offset of the prism 211. This design is particularly important for high-resolution optical systems, preventing imaging blur and decreased resolution due to decentration, thereby ensuring imaging quality and resolution to meet the demands of high-precision optical applications.

The carrier 213 and the rotatable member 214 collectively support the prism 211. Driven by the voice coil driving units, precise rotation of the prism 211 is achieved without requiring additional traditional mechanical connectors like metal shafts or balls. This design reduces the number of components in the system, lowers device complexity, simplifies the assembly process, improves production efficiency and device reliability, reduces maintenance costs, and facilitates the mass production and rapid deployment of optical equipment. The −Y side placement of the plate spring unit 217 reduces their assembly difficulty.

The rotatable member 214 is equipped with the first pivot shafts 2143 and the second pivot shaft 2144, and the axes of these two shafts intersect at the optical center 2111 of the prism 211. This design ensures that rotation of the prism 211 about the X and Z axes is precisely aligned with the optical center, avoiding optical path deviation and decreased imaging quality due to positional misalignment, providing a solid foundation for high-precision optical measurement and imaging.

In this embodiment, the plate spring unit 217 is a one-piece metal plate-like spring, with symmetrical, elastically deformable and recoverable metal elastic parts (the first elastic parts 2174 and the second elastic parts 2175) extending along the X-axis direction and the Z-axis direction. This ensures that the carrier 213 and the rotatable member 214 rotate true (without eccentricity). The design of the plate spring unit 217 not only provides stable and flexible support for the prism 211 but also effectively absorbs external vibrations and shocks through the elastic action of the elastic parts 2174, 2175, reducing the impact on the positioning accuracy of the prism 211 and enhancing system stability and anti-interference capability.

Using plastic material for the first and second pivot shafts 2143, 2144 not only reduces the overall weight of the system, improving portability, but also reduces electromagnetic interference and thermal expansion effects that metal components might cause, enhancing the system's adaptability and performance in complex environments. The choice of plastic material also lowers costs, improves economic efficiency and production efficiency, facilitating mass production and rapid deployment of optical equipment.

In this embodiment, the material of the carrier 213 and the rotatable member 214 is plastic. The first pivot shafts 2143 and the second pivot shaft 2144 are integrally formed with and connected to the rotatable member 214. This may significantly reduce the weight of the camera, improve the portability and operational convenience of the optical system, and also lowers manufacturing costs, improving economic benefits. The first pivot shafts 2143, the second pivot shaft 2144 and the rotatable member 214 may be integrally injection molded, not only reduce the number of components and simplify the assembly process but also enhance structural stability and durability, ensuring the performance stability and reliability of the prism driving device 21 during long-term use, and simplify manufacturing and assembly processes, reduce potential assembly errors, and lower system maintenance complexity. This design facilitates quick field replacement and adjustment, reduces maintenance costs and downtime, and ensures stable operation and long-term reliability of the optical system in complex environments.

The present prism driving device may be used in any periscope telephoto cameras which are suitable for integration into various electronic devices, such as mobile phones, PDA computers, tablet computers, laptops, smart watches, smart wristbands, in-vehicle computers, or television, or surveillance systems.

While the invention has been described in terms of several exemplary embodiments, those skilled on the art will recognize that the invention can be practiced with modification within the spirit and scope of the appended claims. In addition, it is noted that, the Applicant's intent is to encompass equivalents of all claim elements, even if amended later during prosecution.

What is claimed is:

1. A prism driving device, comprising:
a carrier, configured for carrying a prism which is used for refracting light entering from a Y-axis direction to a Z-axis direction perpendicular to the Y-axis direction;
a rotatable member, configured for supporting the carrier;
a first driving unit, configured for driving the carrier to rotate around a first axis relative to the rotatable member, the first axis being parallel with an X-axis direction which is perpendicular to the Y-axis direction and the Y-axis direction;
a base, configured for supporting the rotatable member;
a second driving unit, configured for driving the rotatable member to rotate around a second axis relative to the base, the second axis being parallel with the Z-axis direction;
a plate spring unit, configured for connecting the carrier and the rotatable member, and for connecting the rotatable member and the base;
wherein the plate spring unit is located on a −Y side of the carrier and the rotatable member.

2. The prism driving device according to claim 1, wherein the plate spring unit comprises:
a first fixing part connected to a −Y side end of the carrier;
a second fixing part connected to a −Y side end of the rotatable member;
two third fixing parts connected to a bottom board of the base;
two first elastic parts connected between the first fixing part and the second fixing part; and
two second elastic parts connected between the two third fixing parts and the second fixing part;
wherein the two first elastic parts are symmetrical about the second axis parallel with the Z-axis direction, and the two second elastic parts are also symmetrical about the second axis parallel with the Z-axis.

3. The prism driving device according to claim 2, wherein the bottom board of the base defines an opening; the two third fixing parts of the plate spring unit are connected to a −Y-axis side surface of the bottom board; the first fixing part, the second fixing part, the two first elastic parts and the two second elastic parts are located within the opening.

4. The prism driving device according to claim 1, wherein the rotatable member comprises:
a support beam configured parallel to the X-axis direction;
two first walls connected with two ends of the support beam;
two first pivot shafts configured parallel to the X-axis direction and connected to +Y side ends of the two first walls respectively; and
a second pivot shaft configured parallel to the Z-axis direction and connected to a −Y side part of the support beam;
wherein when viewed from the Y-axis direction, axes of the first pivot shafts and the second pivot shaft intersect at an optical center of the prism.

5. The prism driving device according to claim 4, wherein each first pivot shaft is a pillar with a −Y side part thereof embedded in the +Y-axis side end of the first wall.

6. The prism driving device according to claim 5, wherein the carrier comprises:
a bevel part having a bevel for abutting against the prism;
two second side walls connected to two sides of the bevel parts;
wherein two first recesses are defined in the two second side walls respectively at positions opposite to the two first pivot shafts;
wherein +Y side parts of the two first pivot shafts are rotatable received in the two first recesses to allow relative rotation between the carrier and the rotatable member.

7. The prism driving device according to claim 6, wherein lubricating grease or gel is filled between the first pivot shafts and the first recesses.

8. The prism driving device according to claim 6, wherein the carrier further comprises a boss extending from the bevel part towards the −Y side; a −Y side end of the boss is located at a +Z side of the support beam;
wherein the plate spring unit comprises:
a first fixing part connected to the −Y side end of the boss;
a second fixing part connected to a −Y side part of the support beam of the rotatable member; and
two first elastic parts connected between the first fixing part and the second fixing part;
wherein the two first elastic parts are symmetrical about a first axis parallel with the Z-axis direction.

9. The prism driving device according to claim 4, wherein the −Y side part of the support beam defines a second recess; the second pivot shaft is a pillar with a +Y side part thereof embedded in a bottom of the second recess.

10. The prism driving device according to claim 9, wherein a boss protruding upwardly from the bottom board of the base has a third recess configured for receiving the second pivot shaft; the boss is inserted in the second recess with the third recess receiving the second pivot shaft to allow relative rotation between the rotatable member and the base.

11. The prism driving device according to claim 10, wherein lubricating grease or gel is filled between the second pivot shaft and the third recess.

12. The prism driving device according to claim 11, wherein a fixing boss extends from the support beam of the rotatable member towards the −Y side and is located at a +Z side of the boss of the base;
wherein the plate spring unit comprises:
a second fixing part connected to a −Y side end of the fixing boss of the rotatable member;
two third fixing parts connected to a bottom board of the base; and
two second elastic parts connected between the two third fixing parts and the second fixing part;
wherein the two second elastic parts are symmetrical about a second axis parallel with the Z-axis.

13. The prism driving device according to claim 1, wherein the base comprises:
a bottom board;
a −Z side wall extending upwardly from a −Z side of the bottom board;
a +Z side wall extending upwardly from a +Z side of the bottom board;
a −X side wall extending upwardly from a −X side of the bottom board; and
a +X side wall extending upwardly from a +Z side of the bottom board;
wherein the first driving unit is configured between the carrier and the −Z side wall, and the second driving unit is configured between the rotatable member, the +X side wall and −X side wall.

14. The prism driving device according to claim 1, wherein the plate spring unit is substantially parallel to a plane defined by the X-axis direction and the Z-axis direction.

15. A camera, comprising the prism driving device according to claim 1.

16. An electronic device, comprising the camera according to claim 15.
